(19) United States
(12) Patent Application Publication
(10) Pub. No.: US 2016/0278356 A1
(43) Pub. Date: Sep. 29, 2016

(54) Snag Resistant Drift Fishing Weight Device

(71) Applicant: Richard Warnke, SR., Burlington, WI (US)

(72) Inventor: Richard Warnke, SR., Burlington, WI (US)

(21) Appl. No.: 14/670,452

(22) Filed: Mar. 27, 2015

(51) Int. Cl. A01K 95/00; A01K 97/00

(52) U.S. Cl. CPC A01K 95/00; A01K 97/00

(57) ABSTRACT

A snag resistant drift fishing weight device suspends a slack fishing line over a bottom surface of a body of water. The device includes a cover bead having a convexly rounded upper surface. A loop extends from the upper surface for being coupled to a fishing line by extension through the loop. A tube is coupled to the cover bead such that a bottom edge of the upper surface abuts a top edge of the tube. A weight is coupled to a bottom end of the tube for resting on a bottom surface of a body of water such that the tube extends upwardly supporting the fishing line over the bottom surface of the body of water.

### BACKGROUND OF THE DISCLOSURE

### Field of the Disclosure

The disclosure relates to fishing weight devices and more particularly pertains to a new fishing weight device for suspending a slack fishing line over a bottom surface of a body of water.

### SUMMARY OF THE DISCLOSURE

An embodiment of the disclosure meets the needs presented above by generally comprising a cover bead having a convexly rounded upper surface. A loop extends from the upper surface for being coupled to a fishing line by extension through the loop. A tube is coupled to the cover bead such that a bottom edge of the upper surface abuts a top edge of the tube. A weight is coupled to a bottom end of the tube for resting on a bottom surface of a body of water such that the tube extends upwardly supporting the fishing line over the bottom surface of the body of water.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a snag resistant drift fishing weight device according to an embodiment of the disclosure.

FIG. 2 is a front view of an embodiment of the disclosure.

FIG. 3 is a top front side perspective view of a tube of an embodiment of the disclosure.

FIG. 4 is a side view of an embodiment of the disclosure in use.

FIG. 5 is a partially exploded view of an embodiment of the disclosure.

### DESCRIPTION OF THE PREFERRED EMBODIMENT

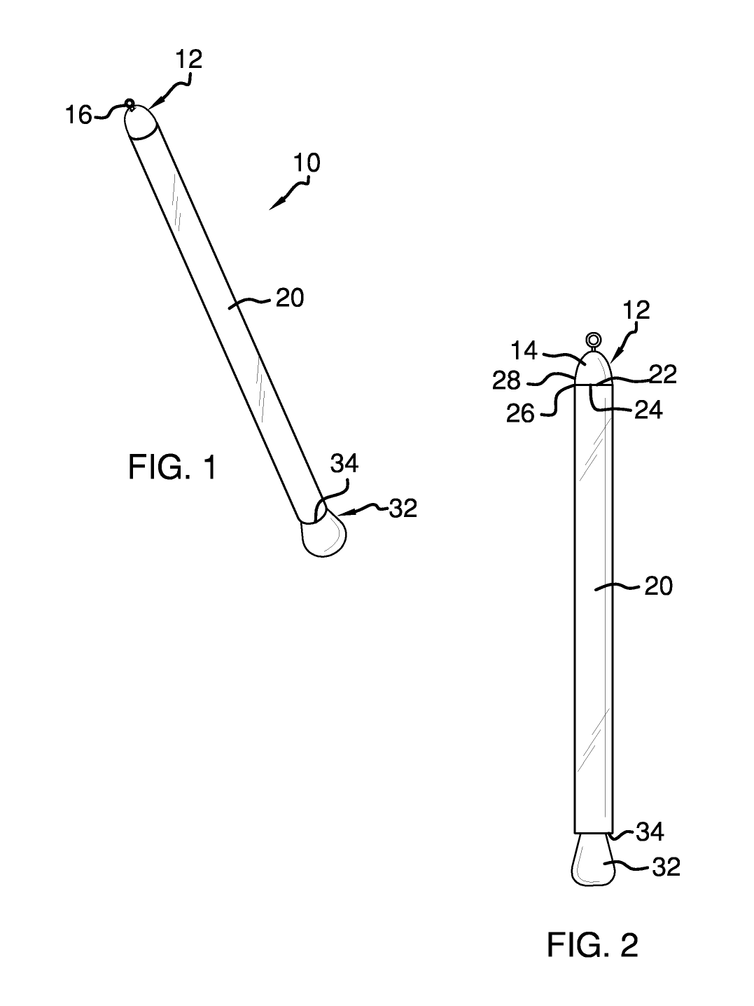

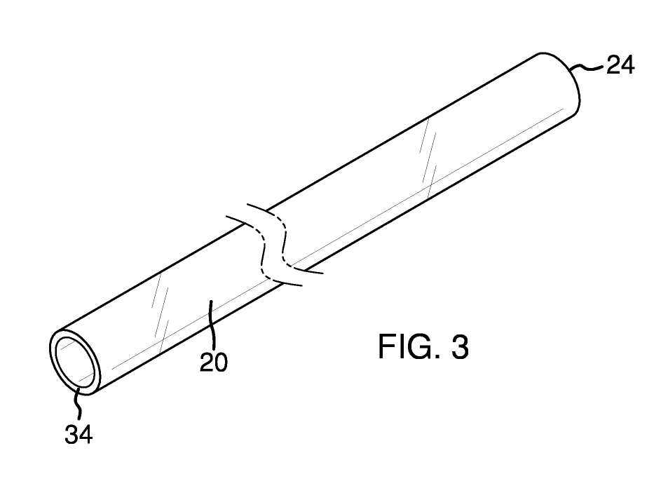

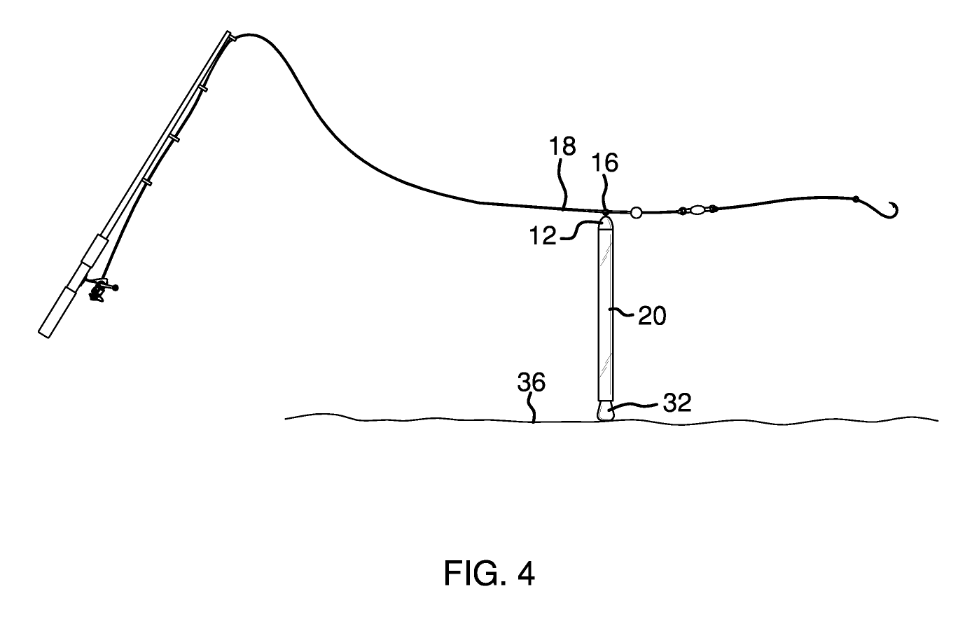

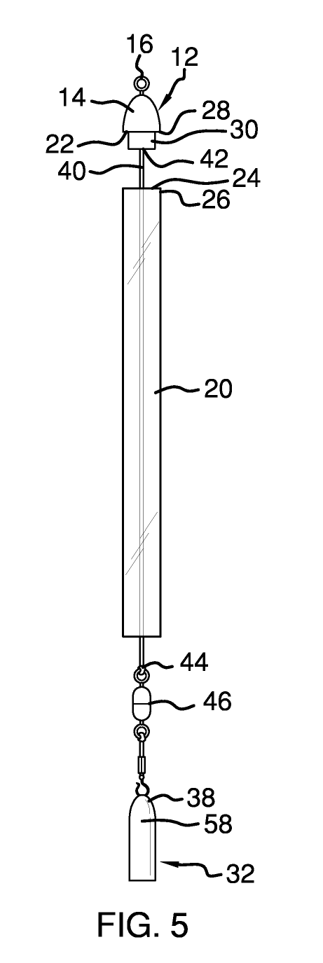

With reference now to the drawings, and in particular to FIGS. 1 through 5 thereof, a new fishing weight device embodying the principles and concepts of an embodiment of the disclosure and generally designated by the reference numeral 10 will be described.

As best illustrated in FIGS. 1 through 5, the snag resistant drift fishing weight device 10 generally comprises a cover bead 12 having an upper surface 14. The upper surface 14 is convexly rounded and has a parabolic shape. A loop 16 is coupled to and extends from the upper surface 14 of the cover bead 12 wherein the cover bead 12 is configured for being coupled to a fishing line 18 extending through the loop 16. A tube 20 is coupled to the cover bead 12 such that a bottom edge 22 of the upper surface 14 abuts a top edge 24 of the tube 20. An outer perimeter 26 of the top edge 24 of the tube 20 is flush with an outer periphery 28 of the bottom edge 22 of the upper surface 14 of the cover bead 12 when the bottom edge 22 of the upper surface 14 abuts the top edge 24 of the tube 20 to inhibit snagging of the device 10 when the fishing line 18 is reeled in. The cover bead 12 has a neck 30 extending downwardly relative to the bottom edge 22 of the upper surface 14. The neck 30 is insertable into the tube 20 and frictionally engages the tube 20 to secure the cover bead 12 to the tube 20 and inhibit water from entering the tube 20 through a gap between the cover bead 12 and the top edge 24 of the tube 20. The tube 20 is transparent.

A weight 32 is coupled to a bottom end 34 of the tube 20 wherein the weight 32 is configured for resting on a bottom surface 36 of a body of water such that the tube 20 extends upwardly supporting the fishing line 18 over the bottom surface 36 of the body of water. A top surface 38 of the weight 32 is rounded and parabolic for insertion into the bottom end 34 of the tube allowing an outer surface 58 of the weight 32 to abut the bottom end 34 of the tube 20 to inhibit water from entering the tube 20 through the bottom end 34. A cord 40 extends through the tube 20. The cord 40 has a top end 42 coupled to the cover bead 12. The cord 40 has a bottom end 44 coupled to the weight 32. The cord 40 is resiliently stretchable holding the weight 32 in tension against the bottom end 34 of the tube 20. A swivel 46 is coupled between the bottom end 44 of the cord 40 and the weight 32. The swivel 46 is extendable outside of the tube 20 when the weight 32 is pulled outwardly away from the tube 20 to facilitate disengagement of the weight 32 and/or cover bead 12 from the tube 20.

In use, the fishing line 18 is strung through the loop 16 proximate a hook 66 on the fishing line 18. The fishing line 18 is cast into the body of water and the weight 32 drifts to rest on the bottom surface 36. The tube 20 provides buoyancy to be upright extending from the bottom surface 36 to support the fishing line 18 in spaced relationship over the bottom surface 18. The length of the tube 20 defines a distance of spacing to support the fishing line over vegetation on the bottom surface 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A snag resistant drift fishing weight device comprising:
a cover bead having an upper surface, said upper surface being convexly rounded;
a loop coupled to and extending from said upper surface of said cover bead wherein said cover bead is configured for being coupled to a fishing line extending through said loop;
a tube coupled to said cover bead such that a bottom edge of said upper surface abuts a top edge of said tube; and
a weight coupled to a bottom end of said tube wherein said weight is configured for resting on a bottom surface of a body of water such that said tube extends upwardly supporting the fishing line over the bottom surface of the body of water.

2. The device of claim 1, further comprising said upper surface of said cover bead having a parabolic shape.

3. The device of claim 1, further comprising a cord extending through said tube, said cord having a top end coupled to said cover bead, said cord having a bottom end coupled to said weight.

4. The device of claim 3, further comprising a swivel coupled between said bottom end of said cord and said weight.

5. The device of claim 4, further comprising said cord being resiliently stretchable wherein said swivel is extendable outside of said tube when said weight is pulled outwardly away from said tube.

6. The device of claim 1, further comprising said tube being transparent.

7. The device of claim 1, further comprising an outer perimeter of said top edge of said tube being flush with an outer periphery of said bottom edge of said upper surface of said cover bead when said bottom edge of said upper surface of said cover bead abuts said top edge of said tube.

8. A snag resistant drift fishing weight device comprising:
a cover bead having an upper surface, said upper surface being convexly rounded, said upper surface of said cover bead having a parabolic shape;
a loop coupled to and extending from said upper surface of said cover bead wherein said cover bead is configured for being coupled to a fishing line extending through said loop;
a tube coupled to said cover bead such that a bottom edge of said upper surface abuts a top edge of said tube, an outer perimeter of said top edge of said tube being flush with an outer periphery of said bottom edge of said upper surface of said cover bead when said bottom edge of said upper surface of said cover bead abuts said top edge of said tube, said tube being transparent;
a weight coupled to a bottom end of said tube wherein said weight is configured for resting on a bottom surface of a body of water such that said tube extends upwardly supporting the fishing line over the bottom surface of the body of water;
a cord extending through said tube, said cord having a top end coupled to said cover bead, said cord having a bottom end coupled to said weight, said cord being resiliently stretchable; and
a swivel coupled between said bottom end of said cord and said weight, said swivel being extendable outside of said tube when said weight is pulled outwardly away from said tube.
